(19) United States
(12) Patent Application Publication
(10) Pub. No.: US 2024/0158298 A1
(43) Pub. Date: May 16, 2024

(54) BACKFILL MATERIAL FOR EARTHING APPLICATIONS

(71) Applicant: DEHN SE, Neumarkt i.d.OPf. (DE)

(72) Inventors: Arunima Shukla, Gurugram (IN); Vikas Almadi, Gurugram (IN); Devesh Jaiswal, Gurugram (IN)

(21) Appl. No.: 18/280,560

(22) PCT Filed: Mar. 4, 2022
(86) PCT No.: PCT/EP2022/055581

§ 371 Date: Sep. 6, 2023

(30) Foreign Application Priority Data
Mar. 19, 2021 (IN) 202111011777

(51) Int. Cl. C04B 24/26; C04B 14/02; C04B 18/08; C04B 111/00; C04B 111/94

(52) U.S. Cl. CPC C04B 24/2652; C04B 14/024; C04B 18/08; C04B 2111/00724; C04B 2111/94

(57) ABSTRACT

A conductive and swellable backfill material for earthing applications comprises a conductive material selected from the group of graphite, coke powder and a combination thereof, a polyacrylamide powder, a binder comprising cement, and, optionally, a salt selected from the group of magnesium sulfate, sodium sulfate and a combination thereof. This unique backfill material enables to utilize the same in low moisture zones because of its low resistivity, high-water absorption, and non-leachable behavior.

The invention relates to a conductive and swellable backfill material for earthing applications.

Lightning protection systems of structures like buildings typically consist of three main parts: an air termination system, a down conductor and an earth termination system.

When a lightning strike hits the lightning protection system, the resulting lightning current is conducted from the air termination system through the down conductor to the earth termination system into the ground. The performance of the earth termination system is crucial for ensuring that the lightning current is effectively dissipated.

One of the most important parameters in this regard is the grounding impedance, which should be kept as low as possible to ensure a rapid dissipation of the lightning current and to avoid back currents. The grounding impedance mainly depends on the type of soil available near the structure and can be lowered by increasing the soil conductivity.

Known solutions for achieving low grounding impedance are chemical treatments of the grounding and the use of backfill materials. In both of these options, chemicals have to be introduced into the ground, which can be washed out over time leading to a steady decrease of soil conductivity and therefore increase of the grounding impedance. Therefore, regular maintenance is necessary which is costly and labor intensive, especially if the site of the lightning protection system is not easily accessible and/or located in a remote area.

Backfill materials are used to encase a metallic rod of the earth termination system, which is buried in the ground. Different types of backfill materials are known, e.g. backfill materials comprising bentonite, cement, carbonaceous substances like charcoal or graphite and/or salts like sodium chloride.

In the review of Abdul-Malek et al. (“The use of enhancement material in ground system: a review”, Indonesian Journal of Electrical Engineering and Computer Science, Vol. 13(2), February 2019, pp. 453-460) different backfill materials are compared with each other, including backfill materials comprising bentonite and palm kernel oil cake (PKOC) organic material.

The article of Priyardarshanee et al. (“Improvement of Earthing Systems with Backfill Materials”, 30^{th} International Conference on Lighting Protection— ICLP 2010, Cagliari, Italy, September 13^{th}-17^{th} 2010) compares the performance of different backfill materials including natural bentonite, metal oxide powder, limestone powder, cork breeze, metal oxide powder and sodium chloride, respectively.

From the article of Bhosle et al. (“Investigation of Effect of Charcoal Particle Size on Earth's resistance”, 2^{nd} IEEE International Conference on Power Electronics, Intelligent Control and Energy Systems, 2018) backfill materials using different types of charcoal are known.

U.S. Pat. No. 3,857,991 A describes an earth resistance-reducing agent comprising a monomer selected from the group consisting of acrylamide, ammonium acrylate, sodium acrylate and sodium methacrylate, at least one water-soluble crosslinking monomer, sodium chloride and/or ammonium sulfate, an oxidizing component and a water-soluble polymer. Therefore, a high number of chemical species are used which are not environmental friendly and are therefore not suitable for use in many applications.

U.S. Pat. No. 4,786,388 A shows backfill materials for ground bed anodes comprising Portland cement, calcined fluid petroleum coke, naturally occurring graphite flakes, and viscosity reducers like surfactants. However, the presented surfactants are not environmental friendly.

From US 2005/0194576 A1 a curable electrically conductive and carbonaceous cement is known which comprises a slurry made of water, a hydraulic cement, a particulate, an electrically conductive form of carbon and discontinuous discrete fibers of a material chemically stable in the slurry. The fibers are e.g. recycled cellulose, recycled polyester, fiberglass or polypropylene. Therefore, the backfill material may introduce a considerable amount of non-degradable and not environmentally friendly constituents into the ground.

From the above it becomes clear that there is still a need for backfill materials, which comprise no or at least reduced amounts of environmentally questionable components while still having long-term service life.

Therefore, the object of the invention is to at least partially overcome the deficiencies of known backfill materials.

The object of the invention is solved by means of a conductive and swellable backfill material for earthing applications comprising a conductive material selected from the group of graphite, coke powder and a combination thereof, a polyacrylamide powder, a binder comprising cement, and, optionally, a salt selected from the group of magnesium sulfate, sodium sulfate and a combination thereof.

The backfill material according to the invention is specifically designed to swell upon contact with water, which can be present by means of soil water, rain or manual application upon installation of the backfill material.

The swelling process allows the backfill material to fill up any voids or air pockets which might be present in an earth hole in which the backfill material is filled. Also, this effect reduces the amount of backfill material necessary to fill up an earth hole of given volume and provides for an especially homogenous backfill material.

Furthermore, the swelling process provides an enhanced contact with a metallic rod or electrode used in an earth termination system in conjunction with the backfill material, e.g. a rod comprising or consisting of copper, aluminium and/or stainless steel. At the same time, the enhanced contact reduces the extent of corrosion of the metallic rod or electrode.

The high amount of swelling of the backfill material according to the invention allows for retaining any absorbed water for extended periods of time, thereby also reducing the risk that the backfill material dries out which could lead to crack formation and thereby to an increase in resistivity. With other words, the backfill material according to the invention is especially long-term stable.

Also, the amount of substances leached from the backfill material is reduced, as the swelled material forms a barrier against diffusion processes of the individual components of the backfill material. The low rate of leaching has the further effect that the properties of the backfill material according to the invention are stable over extended periods of time, i.e. there are only minimal fluctuations e.g. in the grounding resistance achieved by the backfill material.

The water-responsive properties of the backfill material have the further advantage that freeze and thaw cycles do not negatively affect the backfill material, thereby improving the long-term stability of the backfill material.

In addition, it has been found that the backfill material according to the invention does not show formation of fulgurites after exposure to a lightning strike. With other words, the backfill material according to the invention is a fulgurites-free backfill material and earth enhancement compound, respectively.

The main component responsible for the swelling capability of the backfill material according to the invention is the polyacrylamide powder. In other words, the gelling capabilities of the polyacrylamide powder are used to provide the backfill material with the capability for swelling.

Polyacrylamide is environmental friendly and non-toxic. Furthermore, polyacrylamide can have a positive effect on plant growth.

In one variant, the polyacrylamide powder comprises an anionic polyacrylamide powder. The use of anionic polyacrylamide further increases the maximum amounts of water absorbable during swelling.

Preferably, the polyacrylamide powder has at least one of the following properties.

The individual particles in the polyacrylamide powder can have a particle size in the range of from 20 to 80 mesh (US). If the particle size is lower than 20 mesh (US), the particle size in the powder becomes too large which can make it harder to obtain a homogenous backfill material. Furthermore, there is an increased risk that the particles of the polyacrylamide powder settle in the backfill material. If the particle size is larger than 80 mesh (US), the polyacrylamide powder is expected to have a very high surface area, and obtaining a homogenous backfill material can be difficult. Additionally, agglomeration of the particles can be increased which hinders the swelling process, thereby reducing the swelling capabilities of the overall backfill material.

The US mesh size can be determined according to ASTM E11-01. Determination of geometrical properties of aggregates and determination of particle size distributions can be determined by sieving methods according to BS EN 933-1:2012.

The polyacrylamide powder can have a bulk density in the range of from 850 to 950 kg/m 3, preferably of from 880 to 920 kg/m 3, e.g. of 900 kg/m 3. If the bulk density is too low, the polyacrylamide powder and the backfill material are harder to compact, which results in higher costs during packaging and transportation of the polyacrylamide powder and the backfill material.

The bulk density can be measured according to IS 2386-3 (1963): “Methods of test for aggregates for concrete” Part 3: “Specific gravity, density, voids, absorption and bulking”.

Preferably, the polyacrylamide powder has a gelling index of at least 1 kg in 1000 L water at a gelling duration of from 65 to 300 seconds, preferably at a gelling duration of 100 seconds. The gelling index can be determined according to ASTM D5890-19. The gelling index defines the mass of water taken up by the powder to be tested during the gelling duration. If the gelling index is lower, the backfill material does not show a sufficient level of swelling upon exposure to water, which reduces the long-term stability of the backfill material.

The binder provides mechanical stability to the backfill material, especially long-term mechanical stability.

In one variant, the binder comprises a cement selected from the group consisting of Ordinary Portland Cement (OPC), Portland Pozzolana Cement (PPC), Sulfate Resisting Cement, Blast Furnace Slag Cement and combinations thereof.

Preferably, the cement is a rust-free cement to reduce the rate of corrosion of the backfill material and of the rod or electrode used in an earth termination system in conjunction with the backfill material.

The binder can consist of the cement.

The conductive material selected from the group of graphite, coke powder and a combination thereof provides the backfill material with high conductivity, and accordingly with low resistivity.

Optionally, a salt selected from the group of magnesium sulfate, sodium sulfate and a combination thereof is used in the backfill material according to the invention. The salt can be used for further reducing the resistivity of the backfill material. Additionally, magnesium sulfate and sodium sulfate are hygroscopic and therefore can further increase the water uptake of the backfill material.

In one embodiment, the dry backfill material comprises from 35 to 80 weight percent, preferably from 35 to 60 weight percent, of the conductive material, from 10 to 30 weight percent of the polyacrylamide powder, from 5 to 6 weight percent of the binder, and from 0 to 40 weight percent, preferably of from 10 to 40 weight percent, of the salt, each based on the total amount of solid components of the backfill material.

In another embodiment, the backfill material further comprises Fly Ash. Fly Ash is a waste product of the combustion in coal-fired power plants and is therefore cheap and readily available. Fly Ash can further decrease the resistivity of the backfill material.

Preferably, the Fly Ash is free of toxic compounds, especially free of heavy metals, and is treated or selected to have a reduced content of sulphur.

In the backfill material, the total sulphur content is preferably less than 2 weight percent, based on the total amount of solid components of the backfill material, as defined in ISO 14869-1 and IEC 62561— part 7. The type and amount of Fly Ash can be used to control the total sulphur content of the backfill material.

The dry backfill material can comprise 10 weight percent or less of Fly Ash, based on the total amount of solid components of the backfill material.

For ensuring a sufficient extent of swelling, the backfill material according to the invention especially shows a water absorption of at least 110% after 24 hours upon exposure to water based on the mass of the dry backfill material, preferably of at least 140%, more preferably of at least 150%.

Water absorption was measured according to BS EN 1097-6:2013.

The backfill material especially has a resistivity of 0.12 Om or less for ensuring that lightning currents can be effectively dissipated into the earth when the backfill material is used in an earth termination system of a lightning protection system.

The resistivity can be measured by the Wenner 4 probe method according to IEC 62561— part 7.

Preferably, the backfill material has a pH value in the range of from 6.50 to 7.50. With other words, the backfill material preferably is non-corrosive to avoid that a rod or electrode used in conjunction with the backfill material is corroded by the contact to the backfill material.

Further advantages and properties of the invention become apparent by the following description of preferred embodiments and examples, which are to be understood as non-limiting and illustrative only, and the Figures.

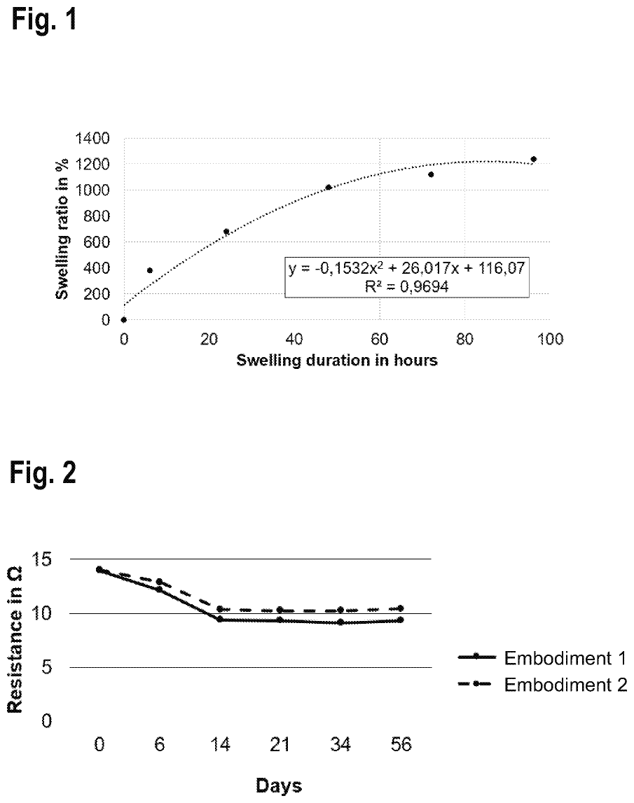

FIG. 1 shows a diagram of the swelling ratio of polyacrylamide powder used in a backfill material according to the invention in dependence of time; and

FIG. 2 shows the resistance of two embodiments of the backfill material according to the invention in dependence of time.

Composition and Properties of the Backfill Material

In Table 1, the compositions of two embodiments of a backfill material according to the invention is shown.

TABLE 1
Components of the dry backfill material according to
the invention; all values are given in weight percent,
based on the total amount of solid components.

| Component | Embodiment 1 | Embodiment 2 |
|---|---|---|
| Graphite | 35 to 60 | 35 to 80 |
| Coke Powder | 0 | 2 to 50 |
| Polyacrylamide | 10 to 30 | 10 to 30 |
| powder | | |
| Cement | 5 to 6 | 5 to 6 |
| Magnesium sulfate | 15 to 25 | 0 to 20 |
| Sodium sulfate | 10 to 15 | 0 |
| Fly Ash | 0 to 5 | 0 to 5 |

Gelling Capability of the Polyacrylamide Powder

The polyacrylamide powder used in Embodiment 1 and Embodiment 2 was tested for gelling capability.

For this, 5 g of the polyacrylamide powder were placed in 50 mL of tap water in a beaker and left without disturbance for 6 hours.

Then, excess water was filtered from the swelled mass, i.e. gel, and the weight of the material was measured. Thereafter, another 50 mL of tap water was added and the mixture left without disturbance again.

This procedure was repeated several times with the weight of the resulting gel additionally measured after 24, 48, 72 and 96 hours (i.e. a total of six cycles, resulting in a total volume of tap water of 300 mL) and a swelling ratio (w/w) was determined based on the ratio of the weight after swelling and the initial weight before swelling. Table 2 and FIG. 1 show the swelling ratio of the gel in relation to the swelling duration.

TABLE 2
Swelling ratio (w/w) of polyacrylamide powder.

| Swelling duration in hours | Swelling ratio in % |
|---|---|
| 0 | 0 |
| 6 | 384 |
| 24 | 680 |
| 48 | 1020 |
| 72 | 1120 |
| 96 | 1240 |

It becomes evident that the polyacrylamide powder shows excellent swelling capability of up to 1240% (w/w) after 96 hours. Therefore, the polyacrylamide powder can serve as a main component to obtain a swellable backfill material.

Preparation of the Backfill Material

For preparation of the dry backfill material, all components listed in Table 1 were mixed together in a beaker and were thoroughly stirred by a stirring rod for approximately 3 minutes.

Afterwards, 500 g of the dry backfill material was mixed with 500 mL tap water in a beaker for preparing a slurry, wherein the backfill material was poured in 3 parts into the beaker while adding the tap water.

The resulting slurry was then poured in molds and were dried for a duration of from 24 up to a maximum of 72 h at a temperature of 100° C. in an oven to test for thermal stability. The duration was chosen such that the mass of the sample became constant which indicates that drying of the sample is complete.

Table 3 lists different properties of the slurries prepared this way.

TABLE 3
Properties of the dry backfill materials of
Table 1 and of slurries prepared therewith.

| Property | Embodiment 1 | Embodiment 2 |
|---|---|---|
| Resistivity in Ωm | 0.02 to 0.12 | 0.02 to 0.12 |
| pH | 6.50 to 7.50 | 6.50 to 7.50 |
| | Non-corrosive | Non-corrosive |
| Water absorption after | 114.87 to 155.55 | 154.7 to 355.55 |
| 24 hours in percent | | |
| Setting time in days | 1 to 3 | 1 to 3 |
| Color | Black | Black |
| Structure before slurry | Powder | Powder |
| preparation | | |
| Smell | None | None |
| Solubility in water | Insoluble | Insoluble |
| Leachability and | None | None |
| dissolution | | |
| Freeze-Thaw cycles | No effect | No effect |
| Copper bonding | Strong | Strong |
| Moisture loss in weight | 28.04 to 32.25 | 21.28 to 31.25 |
| percent at 100° C. | No effect on physical | No effect on physical |
| | properties | properties |
| Flow in % | 42.5 to 82.5 at w/s = 1 | 92 to 97.5 at w/s = 1 |

Water absorption was measured according to BS EN 1097-6:2013. For the measurements, cubic samples with a volume of 125 cm 3 were prepared by filling the respective slurry in a mold and complete drying in an oven. The sample was then completely immersed for 24 hours in a tub filled with tap water. The water absorption is then calculated as

$$Water absorption in \% = \frac{Mass ( saturated ) - Mass ( dry )}{Mass ( dry )} \times 100 \%$$

The “setting time” is defined as the time necessary for the slurry to lose its plasticity after being filled in the mold. In other words, after the setting time, the slurry has transformed from being fluid to being solid.

Copper bonding was checked by filling an earth-pit with the slurry with a copper rod being arranged centrally in the earth pit and letting the slurry rest for 24 hours. The copper bonding is termed “strong” if, after this period, the copper rod could not be extracted manually from the at least partially settled backfill material. A strong copper bonding prevents the copper rod from being vandalized.

For testing the effect of freeze and thaw cycles on the backfill material, with a single cycle comprising cooling the slurry down to −4° C. followed by thawing through storage at room temperature, a total of three cycles were used, with each cycle having a total duration of 24 hours.

The moisture loss at high temperatures was checked by measuring a starting weight of the cubic sample as prepared above after being stored for 24 hours in tap water, drying the sample in an oven at 100° C. until the mass of the sample was constant and then measuring the resulting weight of the sample.

Flowability is measured with a flow table according to IS 5512 (1983) and is a measure of the workability and the consistency of a mortar, therefore defining information for installation characteristics of the slurry. A cone with a fixed diameter D₀ of 10 cm was used in which the respective slurry is filled with a water:solid (w/s) ratio of 1. At the end of the measurement, the diameter D_{avg} of the slurry on the flow table is measured and the flow is calculated according to

$$Flow in \% = \frac{{D}_{avg} - {D}_{0}}{{D}_{0}} \times 100 \%$$

Field Trials of the Backfill Material

For preparation of field trials of the backfill material, the average resistivity of soil at the place of the later field trial was determined. This information is necessary for determining how much reduction in the resistivity will be required and/or is achieved after application of the backfill material.

For this, the Wenner 4-probe method was applied, wherein the measurements were done with different distances between the probes. A hole depth of 15 to 20 cm was used with a probe length of 30 cm.

The Wenner 4-probe method is described in Frank Wenner: “A method of measuring earth resistivity”, Journal of the Washington Academy of Sciences, Oct. 4, 1915, Vol. 5, No. 16, pp. 561-563.

The resistance has been determined in north, east, south and west directions originating from the test spot. Measurements were done using a multimeter commercially available from Fluke Corporation. The obtained measurement values are listed in Table 4.

TABLE 4
Results of Wenner 4-probe measurements.

| | Resistance | Resistance | Resistance | Resistance |
|---|---|---|---|---|
| | in North | in East | in South | in West |
| Probe | direction | direction | direction | direction |
| distance | in Ω | in Ω | in Ω | in Ω |
| 1 m | 9.44 | 8.91 | 2.79 | 9.87 |
| 2 m | 7.78 | 4.88 | 2.32 | 4.77 |
| 5 m | —* | 1.77 | —* | 1.13 |
| 8 m | —* | 0.96 | —* | 0.54 |

*No measurements in North and South directions with a probe distance of 5 and 8 m were possible due to restrictions of the available space.

As the depth of the holes used in the experiments is much lower than the distance between the probes, the resistivity can be calculated from the measured values according to

p=2πaR

with “a” being the probe distance and “R” being the resistance.

In Table 5, the calculated soil resistivity is listed, which is averaged over the measured resistance values given in Table 4.

TABLE 5
Soil resistivity.

| | Soil resistivity in Ωm |
|---|---|
| North | 65.97 |
| East | 55.29 |
| South | 23.34 |
| West | 46.15 |

For field trial of the backfill material, earth holes with a depth of 3 m and a diameter of 100 mm were prepared in soil in Manesar (India).

The earth hole was then filled with 17 to 20 kg of the respective backfill material slurry, wherein a copper electrode was placed centrally in the earth hole and encased by the backfill material slurry.

Both backfill materials were observed to swell over time, finally completely filling their respective earth hole. It has been estimated that due to the size of the volume filled merely by swelling of the backfill material, approximately 6 kg of backfill material could be saved.

The resistance of the backfill materials were measured directly after installation and after 6, 14, 21, 34 and 56 days, respectively, by the Fall-off potential method.

In the Fall-off potential method, the copper electrode and two stakes of a length of approximately 30 cm were connected to a multimeter commercially available from Fluke Corporation. The two stakes are placed in a direct line from the copper electrode, with the outer stake having a distance D of 30 m to the copper electrode and the middle stake having a distance of exactly 61.8%×D to the copper electrode. A measurement current of larger 250 mA was used. The results are shown in Table 6 and FIG. 2.

TABLE 6
Resistance of backfill material in field trial.

| Time in | Embodiment 1 - | Embodiment 2 - |
|---|---|---|
| days | Resistance in Ω | Resistance in Ω |
| 0 | 13.99 | 13.99 |
| 6 | 12.14 | 12.87 |
| 14 | 9.40 | 10.32 |
| 21 | 9.32 | 10.22 |
| 34 | 9.11 | 10.22 |
| 56 | 9.32 | 10.40 |

From Table 6 and FIG. 2 it becomes evident that the resistance of the backfill material, and therefore the resistivity of the backfill material, was high directly after installation but lowers over time and then becomes stable.

The observable resistance is in the order of known backfill materials but additionally showed no leaching, no degradation and no corrosive side effects, even when exposed to rain, sun and wind.

During the field trials, strong rainfalls during the rainy season occurred in Manesar (India), including an average rainfall in one month of 184 mm. Still, no leaching of the backfill material has been observed.

Lightning Test

The behavior of the backfill material was further investigated by means of a Lightning Test simulating a short-term lightning strike of pulse shape 10/350 μs and a long-duration lightning strike of constant current for a duration of 0.5 μs.

For this purpose, a test box with dimensions of 25 cm×25 cm×25 cm was provided in a climatic chamber. Within the test box, two metal round wires have been provided in a crossed arrangement and in a vertical distance of 50 mm to each other.

For filling the text box, a mixture of 6 kg of the backfill material according to Embodiment 2 and 6 kg of tap water was used. Mixing of the overall composition was done using an electric paddle mixer.

The mixture was then filled in the test box and given 72 hours of rest for stabilizing the mixture. Then, the resulting test samples were dehumidified in the climatic chamber at 60 to 65° C. and 15% humidity for 7 days to provide dry samples before the Lightning test.

The target current profile for the simulated lightning strikes were then applied via a current generator with a maximum output amplitude of 50 kA (10/350 μs).

For the long-duration lightning strike test, a test box filled with the mixture was prepared having an ignition wire between the crossed round wires, as described in IEC 61400-24:2019-07 Edition 2.0 chapter D.3.2.3.

For testing the behavior upon short-term lightning strikes, a short-term lightning strike was simulated with a pulse having a 10/350 μs wave shape, a maximum peak current of 10 kA, a charge Qₛₕₒᵣₜ of 5 C and a specific energy W/R of 25 kJ/Ω.

The long-duration lightning strike test was done with a duration t_{long} of 0.5 s, a peak current of 200 A and a charge Q_{long} of 100 C.

The test currents used for the short-term lightning strike and the long-duration lightning strike met the lightning current parameters of the first short strike and the long strike as described in IEC 62305-1 Edition 2.0 (2010-12) “Protection against Lightning—Part 1: General principles.” The relevant parameters with their respective tolerances are given in Tables 7 and 8 below.

TABLE 7
Parameters of the short-term lightning strike (impulse
10 kA (10/350 μs)) in the Lightning Test.

| Peak Current | I_{peak, short} | [kA] | −10%/+10% | |
|---|---|---|---|---|
| Charge | Qₛₕₒᵣₜ | [C] | −20%/+20% | |
| Specific energy | W/R | [kJ/Ω] | −10%/+10% | |
| Front time | T₁ | [μs] | <50 | μs |
| Impulse duration | t_{d} | [ms] | <5 | ms |

TABLE 8
Parameters of the long-duration lightning
strike in the Lightning Test.

| | | | |
|---|---|---|---|
| Peak Current | I_{peak, long} | [A] | −10%/+10% |
| Duration | t_{long} | [s] | 10%/+10% |
| Charge | Q_{long} | [C] | −20%/+20% |

Table 9 shows the contact resistance of the test samples before drying, after drying and after the short-term lightning strike. The contact resistance was measured by using a multimeter contacting the two metal round wires of the test box.

TABLE 9
Behavior of the sample

| | | |
|---|---|---|
| Before | After | After short-term |
| drying | drying | lightning strike |

| | | | | | | |
|---|---|---|---|---|---|---|
| R | 0.0019 | Ω | 7.40 | Ω | 23.37 | Ω |
| U | 0.017 | V | 17.75 | V | 17.93 | V |
| I | 8.81 | A | 2.4 | A | 0.767 | A |

As can be seen from the obtained results, the backfill material according to the invention shows low contact resistance R, even after exposure to a short-term lightning strike.

After the long-duration lightning strike, the backfill material was visually inspected. No damage of the backfill material could be observed.

Afterwards, the backfill material was removed from the test box. No further damages were observed.

In addition, no fulgurites have been found in the backfill material after the Lightning test. Accordingly, the backfill material according to the invention can be termed as being a fulgurites-free backfill material for earthing applications.

1. A conductive and swellable backfill material for earthing applications comprising a conductive material selected from the group of graphite, coke powder and a combination thereof, a polyacrylamide powder, a binder comprising cement, and, optionally, a salt selected from the group of magnesium sulfate, sodium sulfate and a combination thereof.

2. The backfill material according to claim 1 wherein the polyacrylamide powder comprises an anionic polyacrylamide powder.

3. The backfill material according to claim 1 or 2 wherein the polyacrylamide powder has at least one of the following properties:
a particle size in the range of from 20 to 80 mesh (US),
a bulk density in the range of from 850 to 950 kg/m 3, and
a gelling index of at least 1 kg in 1000 L water at a gelling duration of from 65 to 300 seconds.

4. The backfill material according to claim 1 wherein the binder comprises a cement selected from the group consisting of Ordinary Portland Cement (OPC), Portland Pozzolana Cement (PPC), Sulfate Resisting Cement, Blast Furnace Slag Cement and combinations thereof.

5. The backfill material according to claim 1 wherein the dry backfill material comprises
from 35 to 80 weight percent of the conductive material,
from 10 to 30 weight percent of the polyacrylamide powder,
from 5 to 6 weight percent of the binder, and
from 0 to 40 weight percent of the salt, each based on the total amount of solid components of the backfill material.

6. The backfill material according to claim 1 wherein the backfill material further comprises Fly Ash.

7. The backfill material according to claim 6 wherein the dry backfill material comprises 10 weight percent or less of Fly Ash, based on the total amount of solid components of the backfill material.

8. The backfill material according to claim 1 wherein the backfill material shows a water absorption of at least 110% after 24 hours upon exposure to water based on the mass of the dry backfill material.

9. The backfill material according to claim 1 wherein the backfill material has a resistivity of 0.12 Ωm or less.

10. The backfill material according to claim 1 wherein the backfill material has a pH value in the range of from 6.50 to 7.50.
